(19) United States
(12) Patent Application Publication
(10) Pub. No.: US 2007/0244651 A1
(43) Pub. Date: Oct. 18, 2007

(54) Structure-Based Analysis For Identification Of Protein Signatures: CUSCORE

(76) Inventors: Carol E. Zhou, Pleasanton, CA (US); Adam T. Zemla, Brentwood, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/735,972

(22) Filed: Apr. 16, 2007

Related U.S. Application Data
(60) Provisional application No. 60/791,999, filed on Apr. 14, 2006.

(51) Int. Cl. G06F 19/00

(52) U.S. Cl. 702/19

(57) ABSTRACT

Disclosed are computational methods, and associated hardware and software products for scoring polypeptide residues that combine the use of a structure-based alignment with a method of selecting against confounding proteins. The scores can be used to identify protein signatures of interest that are useful, e.g., as targets in developing highly specific ligands for diagnostic or therapeutic uses.

### BACKGROUND OF THE INVENTION

1. Field of the Invention

The present invention relates to the field of bioinformatics. More specifically, the invention relates to computational methods for scoring residues based on structural alignment and residue similarity metrics. The invention also relates to methods for identifying protein signatures from the computed scores.

2. Background of the Invention

A motif or signature is a defined region on a target protein that may be used to specifically identify that protein or, indirectly, the organism that produces it. There is increased need to rapidly develop highly specific diagnostic and therapeutic reagents and detection assays for proteins or organisms which cause biological threat. The identification of signatures conserved or unique to proteins or organisms of interest such as pathogens or toxins allows the rapid development of these reagents and detection assays.

Non-computational methods of identifying protein signatures for high-affinity ligand-based detection include generation of antibodies to whole organisms, whole proteins or peptides. Non-computational methods of identifying protein signatures for reagent development include screening of compounds. In addition to being costly and time-consuming, non-computational methods are based on the principle of discovery and provide no a priori quantitative characterization of the protein residues forming the signature. Consequently, traditional methods based on, e.g., antibody generation or compound library screens provide little information that can be used for down-selecting or targeting the possible pool of reagents.

Current computational methods for identifying protein signatures are largely based on polypeptide sequence analysis. Sequence alignments are carried out using utilities such as, e.g., BLAST (available from the National Center for Biotechnology Information website). From such sequence alignments, conserved residues can be identified. This type of analysis can be used for assigning putative functions to proteins or protein domains, as well as for evaluating relatedness or divergence of two or more sequences. Despite the power of sequence alignment techniques, they suffer from several shortcomings. For example, the use of sequence alignment as a first step in identifying protein signatures representative of three-dimensional structures is limiting for several reasons. First, because sequences mutate faster than do overall structures, structural conservation reflective of protein function tends to be incompletely reflected in sequence alignments. Second, sequence alignments are inherently biased towards finding conserved or homologous residues that are contiguous in the primary sequence and therefore can fail to identify structurally conserved residues because of poor local sequence alignment. Further, a signature derived from sequence analysis may not have proximity in three dimensional space and so can fail to form a domain that can be specifically bound by a reagent or otherwise can be unsuitable as a target for ligand development.

While protein signatures may be computationally identified from a group or set of proteins, cross reactivity of reagents or ligands to a group of similar or confounding proteins may occur. Though the set of proteins which cause confounding or cross reactivity is often known a priori and used as validation in non-computational methods, the prior art fails to provide robust methods of selectively identifying protein signatures that have minimal cross reactivity to a group of confounders.

Thus, there is a need for improved computational methods for identifying protein signatures that allows calculation of the structural conservation of a residue in a manner independent of residue position in protein sequence while providing the ability to select against a group of known proteins when scoring residues. The present invention addresses these and other shortcomings of the prior art as described more fully below.

### SUMMARY OF THE INVENTION

In one aspect, the present invention provides a method for calculating a conservation-uniqueness score from a set of aligned three dimensional structures comprising positional information for a plurality of residues. According to the particular embodiment, positional information may include information for an alpha carbon atom, a beta carbon atom, or a side chain atom or any point in space that is resentative of a residue. The set of aligned three dimensional structures comprises a reference polypeptide, a target polypeptide and a near-neighbor polypeptide and is used to create a one-to-one set of correspondences between residues based on a pre-defined cutoff distance between residues. In certain embodiments, this one-to-one set of correspondences comprises 3 or more residues. The conservation-uniqueness score is generated using similarity metrics to calculate conservation of the reference polypeptide residues relative to target polypeptide and uniqueness relative to a near-neighbor polypeptide. These scores are then combined, for example by addition, subtraction, multiplication or division, to form a score representative of residue conservation and uniqueness.

According to various embodiments of the present invention, a structure in the set of aligned three dimensional structures will be defined using x-ray crystallography, electron crystallography, nuclear magnetic resonance, ab initio modeling, or a combination thereof.

In some embodiments of the present invention the pre-defined cutoff distance is less than 10 Angstroms. The stringency of the cutoff distance may be increased in other embodiments by lowering the pre-defined cutoff distance to less than 5 Angstroms.

According various embodiments of the present invention, the target and nearest neighbor polypeptide may be identified using comparisons based on sequence similarity, structural similarity or taxonomy. In most embodiments this method will be extended to incorporate a set of three or more target or near-neighbor polypeptides into the set of aligned three dimensional structures.

In some embodiments of the present invention, the distribution of the scores may be generated in order to further select a subset of residues based on a percentile cutoff.

According to various embodiments of the present invention, different types of similarity metrics may be used. The similarity metric may incorporate information based on a trinary system of residue identity, non-identity and similarity due to membership in a class, information from substitution matrices only or a combination of information from both these sources.

In another embodiment, the present invention provides a method for displaying the scores onto a three dimensional representation of the reference protein. This display is used to identify a structural feature of interest. In certain embodiments, the structural feature of interest comprises three or more residues.

Another embodiment of the present invention provides a method for projecting the scores onto a linear representation of the polypeptide sequence.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides a visualization of a set of residue-residue correspondences generated from a pair-wise structural comparison of structural homologs. In this visualization, bars represent proteins with the N-terminus at left and C-terminus at right. The proteins have been aligned using Local Global Alignment (LGA) with a reference (ricin) polypeptide. Target structures (Ricin A PDB structures) are represented by the top 3 bars. Near neighbor structures (ricin-like structures) are represented by the next 31 bars. The last 3 bars representing near neighbor structures selected from distant structure homologs. The proteins are labeled on the left according to PDB identifier and labeled on right by measure of structure similarity. Colors represent distance deviations between C-alpha carbons: green<2.0 Å, orange yellow 4.0-<6.0 Å, red>=6.0 Å. Boxes (R1-R6) delineate regions with high structural conservation and uniqueness. Structural conservation among ricin A structures and deviation from near-neighbors can be visualized by the distance deviations of the residues in the correspondence.

FIG. 2 illustrates a plot of the conservation uniqueness scores (cuScores) over linear sequence for residues of a reference polypeptide (ricin A). Pink squares denote cuScores and yellow triangles denote pScores at window size=4. Bars R1-R6 delineate regions identified to have high structural conservation uniqueness scores. SHIGARICIN fingerprints are shown as dark red horizontal segments above regions R1-R6.

FIG. 3 shows a mapping of cuScores to the three dimensional structure of a protein. The mapping of cuScores to the structure of ricin A using B-factor column and temperature factor color setting in Rasmol. Wire frame and space fill views are shown. Values range from low to high (range 0.0 to 1.0, see FIG. 2) as: blue-green-yellow-orange-red. Grey indicates undefined scores at the N— and C terminal regions. Arrow points to a central residue within region R2. Region R2 (arrows in a, b) contains residues with high cuScores and high pScores. The blue residues forming a pocket (center of space fill image in panel a) comprise the active site.

FIG. 4 depicts a mapping of cuScores to a three dimensional structural model of West Nile virus envelope glycoprotein. Orange coloring is use to represent residues high (top 25%) cuScores. Blue represents residues with high cuScores and high pScores. The oval marked 1 denotes residues with lowest overall cuScore values. The oval-marked 2 denotes a three dimensional (3D) motif of residues with high pScore and/or high cuScore.

The figures depict various embodiments of the present invention for purposes of illustration only. One skilled in the art will readily recognize from the following discussion that alternative embodiments of the structures and methods illustrated herein may be employed without departing from the principles of the invention described herein.

### DEFINITIONS

Residue: An amino acid residue is one amino acid that is joined to another by a peptide bond. Residue is referred to herein to describe both an amino acid and its position in a polypeptide sequence.

Surface residue: A surface residue is a residue located on a surface of a polypeptide. In contrast, a buried residue is a residue that is not located on the surface of a polypeptide. A surface residue usually includes a hydrophilic side chain. Operationally, a surface residue can be identified computationally from a structural model of a polypeptide as a residue that contacts a sphere of hydration rolled over the surface of the molecular structure. A surface residue also can be identified experimentally through the use of deuterium exchange studies, or accessibility to various labeling reagents such as, e.g., hydrophilic alkylating agents.

Polypeptide: A single linear chain of 2 or more amino acids. A protein is an example of a polypeptide.

Homolog: A gene related to a second gene by descent from a common ancestral DNA sequence. The term, homolog, may apply to the relationship between genes separated by the event of speciation or to the relationship between genes separated by the event of genetic duplication.

Taxonomy: The classification of organisms in an ordered system that indicates natural relationships. As discussed herein, taxonomy is a classification of organisms that indicates evolutionary relationships.

Conservation: Conservation a high degree of similarity in the primary or secondary structure of molecules between homologs. This similarity is thought to confer functional importance to a conserved region of the molecule. In reference to an individual residue or amino acid, conservation is used to refer to a computed likelihood of substitution or deletion based on comparison with homologous molecules.

Distance Matrix: The method used to present the results of the calculation of an optimal pairwise alignment score. The matrix field (i,j) is the score assigned to the optimal alignment between two residues (up to a total of i by j residues) from the input sequences. Each entry is calculated from the top-left neighboring entries by way of a recursive equation.

Substitution Matrix: A matrix that defines scores for amino acid substitutions, reflecting the similarity of physicochemical properties, and observed substitution frequencies. These matrices are the foundation of statistical techniques for finding alignments.

### DETAILED DESCRIPTION

The practice of the present invention will employ, unless otherwise indicated, conventional techniques of computational biology, biophysics, structural biology, evolutionary biology, molecular biology and biochemistry, which are within the skill of the art. Such techniques are explained fully in the literature, such as Singleton et al., Dictionary of Microbiology and Molecular Biology 2nd ed., J. Wiley & Sons (1994), Bourne et al, Structural Bioinformatics, J. Wiley & Sons (2002), Fogel et al., Evolutionary Computation in Bioinformatics, Morgan Kaufmann (2002) and Mount, Bioinformatics Sequence and Genome Analysis, Cold Spring Harbor Laboratory (2001).

As noted above, there is demand for robust methods of computationally determining protein signatures. Accordingly, the present invention provides methods for identifying optimal protein sequence and structure motifs, herein referred to as ‘signatures’, for development of, e.g., detection assays and therapeutics.

These methods are widely applicable for identification of signatures representative of regions suitable for development of diagnostic reagents for proteins expressed by pathogens or associated with disease, virulence, toxicity or for development of therapeutic drugs or antibodies, and reduce the time and cost of such efforts by identifying up front those regions that are optimal for reagent targeting in terms of specificity for the proteins of interest and that pose the least risk in terms of cross-reactivity by other proteins.

The present invention provides methods for scoring residues developed to allow calculation of the structural conservation of a residue relative to one or more close homologs, herein referred to as targets, in a manner independent of residue position in protein sequence. The present invention further provides the ability to select against a group of known proteins, that are different from but similar to the targets, herein referred to as near neighbors, when scoring residues. Accordingly, the present invention provides methods for identifying residues that are conserved within a set of proteins of interest and unique with respect to structurally similar near neighbor proteins.

In addition, the scored residues can be projected onto a three dimensional structure of the protein of interest for signature determination, herein referred to as the reference polypeptide. Such methods provide a way to identify regions on proteins that are surface exposed and amenable to binding by small molecule ligands or antibodies that will specifically recognize the reference polypeptide.

The score or scores generated for the residues are stored on a client device or a server. In some embodiments, the scores are outputted to a display on a client device.

The scored residues are can be projected onto a linear representation of the reference polypeptide. These methods allow for the identification of signatures that are contiguous in two-dimensional sequence, such as linear epitopes. In practice, the methods of the invention allow for identification of structurally conserved residues that are unique with respect to the target as compared to near neighbors without any a priori assessment as to whether those residues are adjacent in the primary structure of the target.

The identification of a signature according to the methods of the invention enables development of reagents such as small chemical ligands or antibodies and assays using such reagents for highly specific detection of the target.

While the present method finds use in detecting any pathogen or target, preferred pathogens include but are not limited to, avian influenza, Ebola virus, dengue virus and the like. Others include SARs (coranavirus). Additionally, the same methods may be used for the detection of bacterial pathogens such as Bacillis anthracis, Escherichia coli, and Yersinia pestis. The method finds further use in the detection of plant based toxins such as abrin and ricin.

In the development of therapeutics, the present invention finds use in the identification of signatures specific to a protein or a region of a protein. Identified signatures for regions such as those conferring virulence, drug resistance or metastatic properties can be used to develop reagents to selectively block functionality of the regions.

### Conservation-Uniqueness Score

The present invention provides method for calculating for one or more residues a score representative of structural conservation and uniqueness relative to a set of near neighbor proteins.

A scoring function maps an abstract concept to a numeric value. Conservation scores are generated to assign a quantitative value to the degree of evolutionary conservation of a residue at a position in the sequence. Evolutionary conservation is defined by the phenomena in which residues at a position in a molecule are not subject to deletion or substitution in molecules within a species or homologous molecules across different species. It is inferred from conservation that the residue is integral to the function of the molecule and a substitution would cause a loss-of-function in the molecule, potentially rendering unviable the organism producing the molecule. Therefore, conservation is used as a measure of the relative functional importance of a residue.

In the present invention, conservation of one or more residues is scored relative to a group of close homologs or target polypeptide sequences. According to the application of the present invention, these sequences may be selected by various processes. In the scoring of conservation, various similarity metrics may be employed.

Scores can be calculated based on comparisons of the target and near neighbor sequence to the reference polypeptide or a consensus residue. A consensus residue can be calculated for a position in a correspondence based on the residue most frequently found in the aligned structures at that position. Scores for residues in every target sequence are generated by comparison to a corresponding reference or consensus residue, the comparison using the selected similarity metric. Scores for residues in each target sequence can then combined into a single conservation score by averaging the score for each residue in the target sequences.

Uniqueness scores are generated to provide a numeric quantity of the uniqueness of the residue relative to a group of near neighbor polypeptides known to confound or have false or superficial similarity to the group of homologs. The uniqueness scores are used to verify the conservation scores actually represent conservation and are not spurious results. The uniqueness scores are calculated using the same methods and processes as outlined above in reference to the conservation scores.

According to various embodiments of the present invention, conservation and uniqueness scores can be combined in various ways. Combining, as referred to herein, is used to designate any mathematical operation or combination of mathematical operations including, but not limited to adding, subtracting, multiplying, or dividing.

In one embodiment, the conservation scores and uniqueness scores are calculated using the same similarity metric. The uniqueness score is then subtracted from the conservation score.

Those skilled in the art will readily recognize the utility and possibilities inherent in combining the conservation and uniqueness scores with other scoring functions and values. In some embodiments the conservation and uniqueness scores can be combined with scores representative of residue frequency in a database of values. By combining these scores, a user can add extra information regarding the relative uniqueness of a residue based on local sequence context. In some embodiments this residue frequency is based on the local sequence context of the residue as described in co-owned application titled Structure Based Analysis for Identification of Protein Signatures: pScore, filed on Apr. 16, 2007, incorporated herein by reference. The conservation and uniqueness scores may also be combined with scores indicative of the probability a residue resides on the surface of the ternary or quaternary structure of a protein. This added information aids in finding residues that are surface exposed and amenable to binding by small molecule ligands or antibodies. It is well known to those of ordinary skill in the art how to assign a probability associated with the likelihood that a residue is a surface residue. Examples of ways to obtain such probabilities include, e.g., computational algorithms such as those implemented in PredictProtein (Rost and Liu, 2003). Another method of predicting surface accessible residues incorporates the use or creation a three dimensional model of the protein structure.

Other embodiments include weighting the conservation or uniqueness scores by the number of targets or near neighbors before or during the combining of the two scores. In another embodiment of the present invention, the conservation or uniqueness scores are assigned weights to modify the stringency of the method. For instance, the uniqueness score may be assigned a lesser value than the conservation score in order to relax the stringency of the method. The use of alternate methods of weighting and normalization based on the number of sequences will be apparent to those skilled in the art.

The generation of score distributions provides many uses for subsequent analyses and summary reports. Examples of such distributions include but are not limited to frequency distributions or probability distributions. In one application of the present invention, percentile cutoffs are employed as a method of selecting residues from the distribution for further analyses. In other embodiments, the scores are “binned” or discretized for further analyses based on this distribution. In other embodiments, the distribution profiles may be stored for subsequent analyses.

### Signature Identification

According to certain embodiments of the present invention, the calculation of scores provides information used in the identification of a subset of residues which form a protein signature.

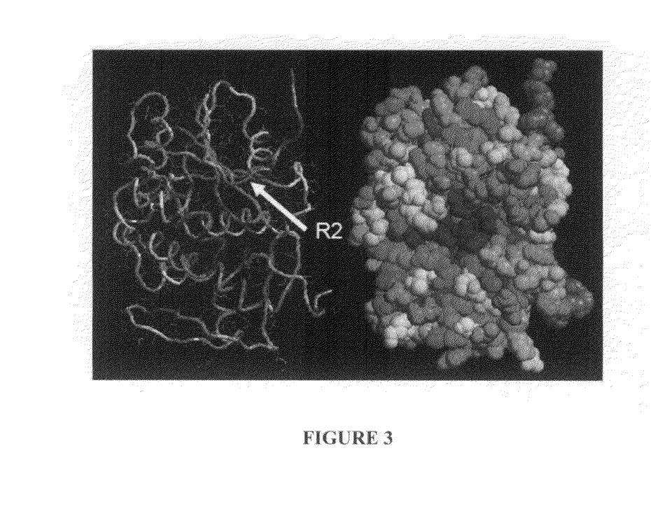

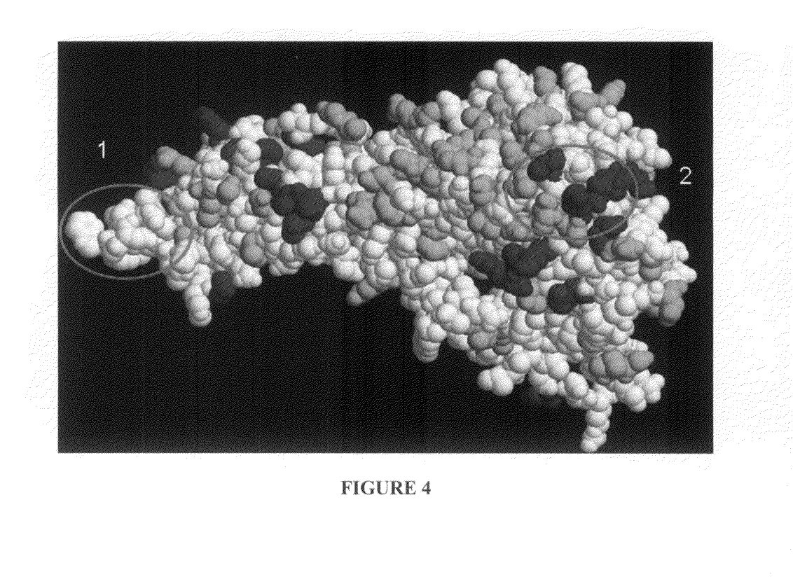

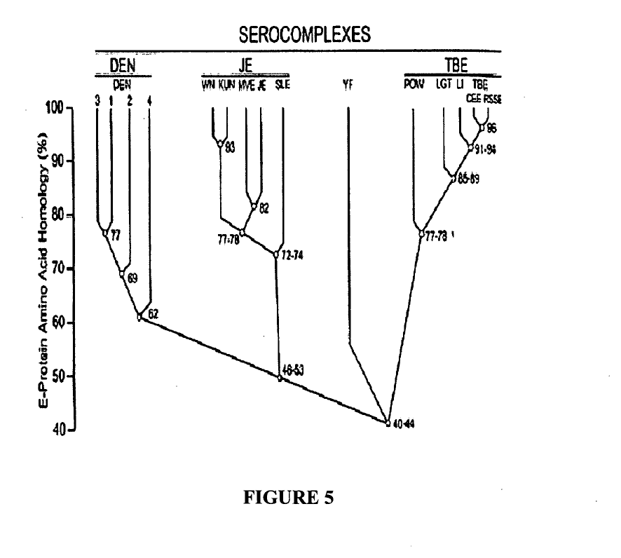

In some embodiments of the present invention, conservation uniqueness scores are displayed onto a three dimensional representation of a polypeptide to identify a set of high scoring residues on the surface of the protein which are proximate in three dimensional space (FIG. 3, FIG. 4). This display is used to identify a set of residues which define a protein signature. This set can contain any number of residues but in most embodiments will be two or more residues, such as, e.g., two three, four, five, six, seven, eight, nine, ten, or more residues. In alternate embodiments, high scoring values with residues proximate in three dimensional space can identified computationally.

In one embodiment, only scores above or below a certain value are displayed on the protein. In another embodiment, residues are colored according to score. In another embodiment, these scores are displayed along with other scores representative of other data such as residue frequency in a database of sequence.

According to the application of the present invention, various programs for rendering the three dimensional display of a protein from a set of atom coordinates are employed in this method. RasMol is a common program for molecular graphics visualization. Other programs used to visualize three dimensional protein structures are Chime and Protein Explorer.

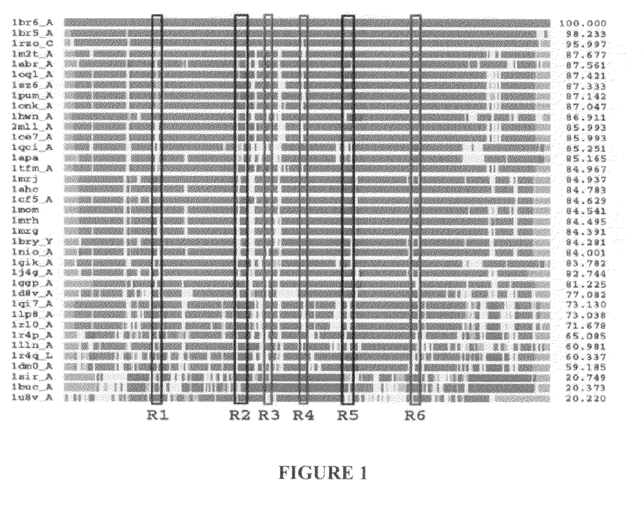

In another embodiment, the conservation uniqueness scores are projected onto a linear representation of the two-dimensional amino acid sequence in order to identify signatures of residues contiguous in linear sequence (FIG. 1). In alternate embodiments, stretches of contiguous residues satisfying set scoring criteria are identified programmatically.

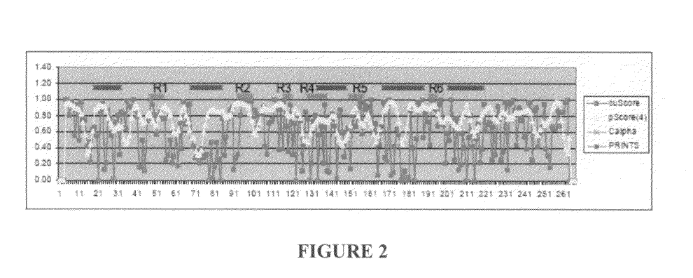

In one embodiment, the scores are displayed as a line graph where the amino acid sequence is plotted along the x-axis and the numeric values of the scores are displayed on the y-axis (FIG. 2). The scores can also be displayed on the y-axis along with other scores including, but not limited to, scores representative of residue frequency in local sequence context. In some embodiments, the scores can be represented by coloring the residues in the correspondence or by other visualization techniques.

### Similarity Metrics

Various similarity metrics are used to score the uniqueness or conservation of the residues in a correspondence. These metrics include but are not limited a trinary system or substitutions matrices. It is expected that those skilled in the art can envision a variety of comparable similarity metrics for calculating conservation and uniqueness.

In one embodiment of the present invention, the similarity metric is based on trinary system of residue identity, non-identity and similarity. Residues from each sequence in a correspondence are compared with the corresponding residue in the reference protein. Alternately, residues from each sequence are compared with a consensus residue identified in the majority of the sequences in set of the correspondences. Residue identity refers to the residue comprising the same amino acid as the residue to which it is compared. Residue similarity refers to the two residues under comparison being part of a pre-defined group or family with similar features. If two residues are neither identical nor similar, the residues are non-identical. Scores of 1, 0 and 0.5 are assigned based on identity, non-identity and similarity respectively. It is expected that those skilled in the art can imagine a variety of different scoring techniques.

Various pre-defined groupings used to specify may be employed in this technique. Amino acids are referred to herein by corresponding single letter symbols as defined by IUPAC (International Union of Pure and Applied Chemistry), a table listing amino acids and their corresponding single letter symbols may be found in a standard biochemistry textbook, for example, Leningher, Priciples of Biochemistry, W H Freeman & Co (2004). One method of grouping the 20 known amino acids is by chemistry and size: aliphatic (AGILPV), aromatic (FWY), acidic (DE), basic (RKH), small hydroxylic (ST), sulfur-containing (CM) and amidic (NQ).

Other grouping schemes are based on functional properties such as: acidic (DE); basic (RKH); hydrophobic non polar (AILMFPWV); and polar uncharged (NCQGSTY). An example of a grouping scheme based on the charge of amino acid is: acidic (DE); basic (RKH) and neutral (AILMFPWV NCQGSTY). A grouping scheme based on structural properties of amino acids is: ambivalent (ACGPSTWY); external (RNDQEHK); internal (ILMFV) (Karlin and Ghandour, 1985). Other grouping schemes based on physical properties such as codon degeneracy or kinetic properties can also be employed.

In an alternate embodiment, substitution matrices may be used to calculate the similarity metric. Substitution matrices represent to the rate at which each possible residue in a sequence changes to each other residue over time. Substitution matrices are 20 by 20 matrices containing preffered substitutions propensity for all possible pairs of amino acids. The preferred substitution propensities may be calculated based on a set of homologous sequences or many sets of homologous sequences. Two substitution matrices for amino acids commonly used in the art are PAM (Point Accepted Mutation) and BLOSUM (BLOck SUbstitution Matrix). Substitution matrices may also be used to create a grouping such as above by identifying the grouping of amino acids which minimizes the off diagonal elements in the substitution matrix (Fygenson et al., 2004).

### Protein Structure Alignment

Protein structure alignments preferably are sets of correspondences between spatial coordinates of sets of carbon alpha atoms which form the ‘backbone’ of the three-dimensional structure of polypeptides, although alignments of other backbone or side chain atoms also can be envisioned. These correspondences are generated by computationally aligning or superimposing two sets of atoms in order to minimize distance between the two sets of carbon alpha atoms. The root mean square deviation (RMSD) of all the corresponding carbon alpha atoms in the backbone is commonly used as a quantitative measure of the quality of alignment. Another quantitative measure of alignment is the number of equivalent or structurally aligned residues.

A variety of methods for generating an optimal set of correspondences can be used in the present invention. Some methods use the calculation of distance matrices to generate an optimal alignment. Other methods maximize the number of equivalent residues while RMSD is kept close to a constant value.

In the calculation of correspondences, various cutoff values can be specified to increase or decrease the stringency of the alignment. These cutoffs can be specified using distance in Angstroms. Depending on the level of stringency employed in the present invention, the distance cutoff used is less than 10 Angstroms or less than 5 Angstroms, or less than 4 Angstroms, or less than 3 Angstroms. One of ordinary skill will recognize that the utility of stringency criterion depends on the resolution of the structure determination.

In another embodiment of the present invention, the set of residue-residue correspondences are created using a local-global alignment (LGA), as described in US Patent Application Number 2004/0185486. In this method, a set of local superpositions are created in order to detect regions which are most similar. The LGA scoring function has two components, LCS (longest continuous segments) and GDT (global distance test), established for the detection of regions of local and global structure similarities between proteins. In comparing two protein structures, the LCS procedure is able to localize and superimpose the longest segments of residues that can fit under a selected RMSD cutoff. The GDT algorithm is designed to complement evaluations made with LCS searching for the largest (not necessary continuous) set of ‘equivalent’ residues that deviate by no more than a specified distance cutoff.

### Protein Structure Modeling

Protein structures are sets of solved atomic coordinates representative of a three dimensional structure of a protein. These coordinates are solved for atoms including, but not limited to, alpha carbons, beta carbons, or side chain atoms. These sets of solved atom coordinates can also represent some substructure of a protein or polypeptide. Atom coordinates may be solved experimentally using a variety of techniques such as x-ray crystallography, electron crystallography and nuclear magnetic resonance.

Despite the accuracy of experimental techniques, they are costly and time-consuming. Advances in protein structure prediction or modeling provide methods of computationally solving the set of atom coordinates for a given protein. These methods are generally based on three different techniques (sequence comparison, threading and ab initio modeling). Protein structure prediction or modeling is usually practiced as a combination of these techniques.

A favored method in the art of protein structure prediction is to find a close homolog for whom the structure is known. CASP (Critical Assessment of Techniques for Protein Structure Prediction) (Moult et al., 2003) experiments have shown that protein structure prediction methods based on homology search techniques are still the most reliable prediction methods. Sequence comparison and threading techniques are based on homology search.

Sequence comparison approaches to protein structure prediction are popular due to availability of protein sequence information. These techniques use conventional sequence search and alignment techniques such as BLAST or FASTA to assign protein fold to the query sequence based on sequence similarity.

Approaches which use protein profiles are similar to sequence-sequence comparisons. A protein profile is an n-by-20 substitution matrix where n is the number of residues for a given protein. The substitution matrix is calculated via a multiple sequence alignment of close homologs of the protein. These profiles may be searched directly against sequence or compared with each other using search and alignment techniques such as PSI-BLAST and HMMer.

It is known that sequence similarity is not necessary for structural similarity. Proteins sharing similar structure can have negligible sequence similarity. Convergent evolution can drive completely unrelated proteins to adopt the same fold. Accordingly, ‘threading’ methods of protein structure prediction were developed which use sequence to structure alignments. In threading methods, the structural environment around a residue could be translated into substitution preferences by summing the contact preferences of surrounding amino acids. Knowing the structure of a template, the contact preferences for the 20 amino acids in each position can be calculated and expressed in the form of a n-by-20 matrix. This profile has the same format as the position specific scoring profile used by sequence alignment methods, such as PSI-BLAST, and can be used to evaluate the fitness of a sequence to a structure.

Ab initio methods are aimed at finding the native structure of the protein by simulating the biological process of protein folding. These methods perform iterative conformational changes and estimate the corresponding changes in energy. Ab initio methods are complicated by inaccurate energy functions and the vast number of possible conformations a protein chain can adopt. The most successful approaches of ab initio modeling include lattice-based simulations of simplified protein models and methods building structures from fragments of proteins. Ab initio methods demand substantial computational resources and are also quite difficult to use, and expert knowledge is needed to translate the results into biologically meaningful results. Despite known limitations, Ab initio methods are increasingly applied in large-scale annotation projects, including fold assignments for small genomes. Recent examples of such applications include Bonneau et al. 2001, Kuhlman et al. 2003 and Dantas et al. 2003.

In practice, protein structure prediction typically involves a combination of the listed techniques, both experimental and computational. Hybrid approaches to protein structure prediction involve using different techniques for solving the atom coordinates at different stages or to solve for different parts of the protein structure. An example of this would be the use of AS2TS (amino acid to tertiary structure, a homology threading threading technique) to facilitate the molecular replacement (MR) phasing technique in experimental X-ray crystallographic determination of the protein structure of Mycobacterium tuberculosis (MTB) RmlC epimerase (Rv3465) from the strain H37rv. The AS2TS system was used to generate two homology models of this protein that were then successfully employed as MR targets.

Meta-predictors or consensus approaches attempt to benefit from the diversity of models by combining multiple techniques. In these methods, predictive models are collected and analyzed from a variety of different computational and experimental techniques. A common approach for combining models by consensus is to select the most abundant fold represented in the set of high scoring models. Other approaches to consensus modeling involve structural clustering such as HCPM-Hierarchical Clustering of Protein Models (Gront and Kolinski, 2005).

In one embodiment of the present invention the protein structures are predicted using the AS2TS program. The AS2TS system uses homology methods to translate sequence-structure alignment data into atom coordinates. For a given sequence of amino acids, the AS2TS (amino acid sequence to tertiary structure) system calculates (e.g. using PSI-BLAST analysis of PDB) a list of the closest proteins from the PDB, and then a set of draft 3D models is automatically created.

### Nearest-Neighbor and Target Selection

A set of nearest neighbors and targets can be selected using various methods of comparison to the reference polypeptide such as sequence similarity, structural similarity, or taxonomy. Those skilled in the art can picture a variety of combinations of the following methods.

A preferred method of finding determining nearest-neighbor or cutoff sets is through the use of structural similarity alignments using programs such as LGA. Using structural similarity comparison, a known protein structure may be aligned with a database of other known structures such as PDB (Protein Data Bank). Cutoff values for targets may be specified using the RMSD or distance between residues in Angstroms. Structures having good alignment but not strong enough alignment to be considered targets may be identified as nearest neighbor structures.

Sequence similarity comparisons form another method of selecting a set of nearest neighbors or targets. Various methods of sequence-sequence comparison (BLAST, HMMer, etc) may be used to generate a metric of sequence similarity and identify close sequence homologs or target polypeptides. Conversely, threshold values may be set to identify near neighbor polypeptides which have lower sequence similarity and are likely to cause interference.

A phylogenic taxonomy provides a known or accepted classification of groups of organisms based on evolutionary relatedness. Taxonomy can be used to determine sets of nearest neighbors or targets. For instance, a group of related organisms may have very similar proteins to the reference protein. Depending on the application of the method, the signature may be used to distinguish a family of related organisms, which would form the set of targets. In contrast, there may be very similar organisms or viruses desirable to select against in the identification of a signature forming the set of near neighbor polypeptides. Phylogeny or taxonomy can be used to identify the largest subset of confounding pathogens or organisms, thus improving the accuracy of the method.

In the absence of a known phylogeny, a calculated molecular phylogeny may be created using sequence similarity comparisons. In these analyses, a distance matrix between similar sequences is created to generate a measure of evolutionary distance. These distances are then clustered to create phylogenetic trees representative of sequence divergence due to evolution. Common algorithms for clustering include neighbor joining and UPGMA(Unweighted Pair Group Method with Arithmetic mean) (Prager and Wilson, 1978). Phylogenetic tree data may be used to select near neighbor and target proteins in the same manner as taxonomy is used.

Given, the availability and accuracy of computational protein structure prediction, those skilled in the art can easily see the benefit of combining identification of nearest neighbor and target polypeptides using taxonomy and sequence similarity with the preferred method of structural alignment through the creation of three dimensional models for the polypeptides. The three dimensional models may then be further evaluated by structural alignment with the reference protein in order to select nearest neighbor and target polypeptides.

### EXAMPLE 1

### The Identification of Conserved/Unique Signatures in the A chain of Ricin

An entry (ID=RICI_RICCO, P02879) from the SHIGARICIN family of the PRINTS database of virulence factors as a reference sequence for our analyses of the A chain of ricin. Of the 21 PDB structures of the ricin A chain, the three non-redundant, non-mutant structures that had been solved with highest resolution (PDB entries 1br6, 1br5 and 1rz0) to include in the target set for our structure-based analyses were selected. These structures had sequence similarity between 93 and 100% (and corresponding structure-similarity LGA_S score between 95 and 100%) to the ricin A reference. Using the AS2TS (Zemla et al., 2005) automated homology-based protein structure modeling system, PDB entry lbr6 was selected as the 3D model structure of the ricin A reference sequence, because it had the greatest sequence similarity (100% sequence identity) and structure completeness from among available PDB structures (100% of structure solved with resolution of 2.3 Å).

The 3D model of the reference ricin A chain was then used to assemble a complete list of all related structures from PDB using LGA (local-global alignment) software, which employs a PDB search method (Zemla, 2003). In our PDB search for related structures, those representing mutants or redundant sequences were removed from consideration; we selected 31 structures from PDB that had significant similarity to our reference model. LGA was used to structurally align the reference structure with the other ricin structures (targets) and with all other related structures (near neighbors) (sequence similarity between 13 and 40%, and corresponding LGA_S between 59 and 87%).

The reference model of ricin A was structurally superimposed and compared with all other structures, and the results of the comparison were sorted by structure-similarity score (FIG. 1). The PDB search, along with the observed clear structural distinction between ricin proteins (LGA_S>93%) and 31 close homologs (near neighbors, LGA_S>59%) allowed us to define a complete set of 34 ricin A or ricin A-like proteins from PDB. A clear structural distinction between the 34 ricin A and related structures and all other structures from PDB was observed; the closest ones had a level of structure-similarity>20%. The ricin A-like proteins mostly consisted of plant lectins with ribosome-inhibiting activity.

For each pair-wise alignment using LGA, distances between corresponding C-alpha carbons were computed. The structure comparison plots (FIG. 1) were examined for regions of structure-similarity among the ricin A structures and structure deviation between ricin A and near neighbors.

The cuScore was devised as a measure of residue conservation/uniqueness in structure context. The sequence homology between ricin and a large number of other proteins (e.g., plant lectins), and the structural homology among ricin and lectins from widely ranging taxa, prompted us to consider the challenge of identifying binding pockets and epitopes (3D motifs) for ricin A diagnostic reagents that would pose minimal risk of cross-reactivity from related proteins. Because structure is more highly conserved than is sequence, we determined that sequence-based analysis among ricin A homologs may be insufficient. Therefore, the cuScore was developed as a means of comparing corresponding residues across a set of structural homologs. A multiple structure-based residue-residue correspondence, which resembles a multiple-sequence alignment, was extracted from the LGA comparison (FIG. 1), and corresponding structurally aligned residues in targets versus near-neighbor homologs were compared.

For each corresponding (co-aligned) position in the set of target proteins, a consensus amino acid was identified as the residue that occurred in more than half of the members of the set. A conservation measure, c, per position was computed between 0 and 1 depending on the degree of conservation at a given position among the corresponding residues of the target set. For each corresponding residue in the set, a score of 1 was assigned if the residue matched the consensus, 0.5 if the residue did not match but occurred within the same amino-acid group [(AGILPV), (FWY), (DE), (RKH), (ST), (CM) and (NQ) or 0 if the residue occurred within a different group. Thus, scores of 1, 0.5 and 0 represented decision states of identity, similarity and dissimilarity, respectively. Our choice of amino-acid groupings for cuScore analysis was based on a grouping that we felt was most appropriate for identifying binding pockets or epitopes suitable for our purposes—namely, one that grouped amino acids based on chemistry and size: aliphatic (AGILPV), aromatic (FWY), acidic (DE), basic (RKH), small hydroxylic (ST), sulfur-containing (CM) and amidic (NQ). Although other grouping schemes (amino-acid alphabets) based on physical properties, substitution propensity, codon degeneracy or kinetic properties (Karlin and Ghandour, 1985; Fygenson et al., 2004) may have yielded quantitatively different results, we did not consider these alphabets to be any more appropriate for our goal of identifying conserved/unique regions for recognition by means of ligand binding.

The conservation measure (c) was computed as the sum of the scores divided by the number of residues in the set, thereby representing an average degree of similarity among corresponding residues. Residues that had not been assigned spatial coordinates were not included in the set. If a consensus residue could not be identified (indicating poor conservation at that position within the target set), the cuScore was immediately set to ‘undefined’ with no further calculation. Each structurally corresponding residue in the set of near-neighbors was then compared to the consensus residue to determine a uniqueness measure (u). Near-neighbor residues were scored according to similarity by determining whether they were identical (score=1), were different but occurred within the same amino-acid group (score=0.5) or occurred in a different group (score=0). Positions representing deletions with respect to the reference (‘-’ in the alignment) were scored 0, as were positions that had been labeled ‘X’ (e.g. non-standard amino acid) in the coordinates file.

The uniqueness measure (u) was calculated as the sum of the scores divided by 31. For each residue in the reference ricin sequence, a cuScore was computed as c-u. In the case that a cuScore were computed to be <0, (indicating greater conservation at that position among near neighbor proteins than within the targets), cuScore would be set to ‘undefined’. cuScores were plotted versus ricin A residue number (FIG. 2). cuScores for residues at the extreme N— and C-terminal regions, for which there was inadequate structural data, were also left ‘undefined’.

Visualization of surface-exposed regions containing residues with high cuScores and/or pScores was facilitated using RasMol (Sayle and Milner-White, 1995) to color code low- to high-scoring residues (FIG. 3). cuScores and pScores were separately loaded into the b-factor column of the reference ricin A 3D coordinates file and displayed using RasMol's color-temperature setting. We used cuScore and pScore (see patent application titled Structure Based Analysis for Identification of Protein Signature: pScore by Carol Zhou, Adam Zemla and Marisa Lam filed Apr. 16, 2007 values and these 3D color plots, along with Naccess (Hubbard and Thornton, 1993) solvent accessibility calculations (data not shown), to visually identify surface loops or binding pockets suitable as antibody or small molecule ligand targets. By visual inspection of the residues comprising region R2 (FIG. 1), we determined that this subsequence was composed mostly of residues with high cuScores and pScores (FIG. 2 and FIG. 3).

### EXAMPLE 2

### Identification of Conserved/Unique Signatures in the West Nile Virus Envelope Glycoprotein

The method of the present invention was also used to identify motifs on the envelope glycoprotein of West Nile virus that satisfy conditions of a) conservation/uniqueness with respect to WNV, versus b) potential cross reactivity with other Flaviviruses. Data from the literature was then used to evaluate the success of these predictions. These analyses suggest that PSE correctly predicted conservation/uniqueness and excluded motifs for which targeted detection reagents would likely cross react with other Flaviviruses.

The envelope glycoprotein of West Nile virus (refseq strain) was selected as the reference sequence and was blasted against the non-redundant (NR) protein database to capture related Flavivirus sequences. The subject and query sequences were then modeled using AS2TS.

Sequences and models were analyzed using the present method for identification of protein signatures, 76 “targets” (WNV) and 248 “near-neighbors” (other Flaviviruses) were compared using LGA to generate the multiple structure-based sequence alignment (MSSA) that was used to compute cuScores.

Residues with the highest cuScores and pScores were mapped onto the WNV model (FIG. 4). Residues with high cuScore and/or pScore values were color coded to facilitate identification of conserved/unique motifs. A region in domain III (FIG. 4, oval #2) composed of high-scoring residues was determined to coincide with a well known neutralizing epitope.

The Immune Epitope Database (Peters et al. 2005) was searched for references to papers describing mAbs that had been epitope mapped to the residue level. Results of binding studies for all such existing mAbs, raised against WNV, SLE, and Dengue2 Flavivirus envelope glycoproteins and described in six publications (Oliphant et al. 2005, 2006; Crill et al. 2004, Roehrig et al. 1998, Megret et al. 1992; Sanchez et al. 2005), were summarized.

Using the present invention, a feature was predicted in the WNV envelope glycoprotein defined by a cluster of residues including S306, K307, T330, and T332 (FIG. 4, oval #2) that display properties of conservation/uniqueness, and that a cluster of residues in the fusion loop (FIG. 4, oval #1) with the lowest scores in our analyses would be unsatisfactory for detection reagent development due to the potential for cross reactivity with other Flaviviruses. WNV mAbs that recognize a neutralizing epitope (Domain IIIa) are highly specific for WNV, failing to bind to many other Flaviviruses, whereas mAbs recognizing the WNV (Oliphant) or SLE (Crill) fusion loop region are cross reactive across the genus, and 3 of 4 mAbs recognizing the fusion loop of Dengue2 are cross reactive to varying degrees within the genus.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims. All references disclosed in this specification, including references to books, scientific articles, patent applications, patents, and other publications are hereby incorporated by reference in their entirety for all purposes.

### REFERENCES

Zhou, C E, A Zemla, D Roe, M Young, M Lam, J S Schoeniger, and R Balhorn. 2005. Computational approaches for identification of conserved/unique binding pockets in the A chain of ricin. Bioinformatics 21:3085-3096
Rost, B., Liu, J. (2005) The PredictProtein server. Nucleic Acids Res. Jul. 1, 2003; 31(13):3300-4.
Gront D., Kolinski A., HCPM—program for hierarchical clustering of protein models. Bioinformatics. July 15; 21(14):3179-80. Epub Apr. 19, 2005.
Moult, J., Fidelis, K., Zemla, A. (2003) Hubbard T., Critical assessment of methods of protein structure prediction (CASP)-round V., Proteins.;53 Suppl 6:334-9.
Prager, E. M., Wilson, A. C. (1978) Construction of phylogenetic trees for proteins and nucleic acids: empirical evaluation of alternative matrix methods. J Mol Evol. June 20; 11(2): 129-42.
Bonneau, R., Tsai, J., Ruczinski, I. and Baker, D. (2001) Functional inferences from blind ab initio protein structure predictions. J. Struct. Biol., 134, 186-190.
Kuhlman, B., Dantas, G., Ireton, G. C., Varani, G., Stoddard, B. L. and Baker, D. (2003) Design of a novel globular protein fold with atomic-level accuracy. Science, 302, 1364-1368. 61.
Dantas, G., Kuhlman, B., Callender, D., Wong, M. and Baker, D. (2003) Alarge scale test of computational protein design: folding and stability of nine completely redesigned globular proteins. J. Mol. Biol., 332, 449-460.
Attwood, T. K., Avison, H., Beck, M. E., Bewley, M., Bleasby, A. J., Brewster, F., Cooper, P., Degtyarendko, K., Geddes, A. J., Flower, D. R., Kelly, M. P., Lott, S., Measures, K. M., Parry-Smith, D. J., Perkins, D. N., Scordis, P., Scott, D., and Worledge, C. (1997) The PRINTS database of protein fingerprints: A novel information resource for computational molecular biology. J Chem Inf Comput Sci, 37, 417-424.
Berman, H. M., Westbrook, J., Feng, Z., Gilliland, G., Bhat, T. N., Weissig, H., Shindyalov, I. N., and Bourne, P. E. (2000) The protein data bank. Nucleic Acids Research, 8, 235-242.
Bower, M. J., Cohen, F. E. and Dunbrack, R. L. (1997) Prediction of protein side-chain rotamers from a backbone-dependent rotamer library: a new homology modeling tool. J Mol Biol, 267, 1268-1282.
Canutescu A. A., Shelenkov A. A. and Dunbrack, R. L. (2003) A graph theory algorithm for protein side-chain prediction. Prot Sci, 12, 2001-2014.
Day, P. J., Ernst, S. R., Frankel, A. E., Monzingo, A. F., Pascal, J. M., Molina-Svinth, M. C. and Robertus, J. D. (1996) Structure and activity of an active site substitution of ricin A chain. Biochemistry, 35, 11098-11103.
Ewing, T. J. A., S. Makino, A. G. Skillman, I. D. Kuntz. 2001. DOCK 4.0: Search strategies for automated molecular docking of flexible molecule databases. Journal of Computer-Aided Molecular Design 15: 411-428.
Fygenson, D. K., Needlemen, D. J. and Sneppen, K. (2004) Variability-based sequence alignment identifies residues responsible for functional differences in a and b tubulin. Protein Science, 13, 25-31.
Gabdoulkhakov, A. G., Savochkina, Y., Konareva, N., Krauspenhaar, R., Stoeva, S., Nikonov, S. V., Voelter, W., Betzel, C., Mickhailov, A. M. Structure-Function Investigation Comlex of Agglutinin from Ricinus Communis with Galactoaza (to be published).
Gardner, S., Lam, M. W., Mulakken, N. J., Torres, C. L., Smith, J. R. and Slezak, T. R. (2004) Sequencing needs for viral diagnostics. Journal of Clinical Microbiology, 42, 0095-1137.
Hubbard, S. J. and Thornton, J. M. (1993) ‘NACCESS’, Computer Program, Department of Biochemistry and Molecular Biology, University College, London.
Karlin, S. and Ghandour, G. (1985) Multiple-alphabet amino acid sequence comparison of the immunoglobulin k-chain constant domain. Proc. Natl. Acad. Sci. USA, 82, 8597-8601.
Knight, B. (1979) Ricin—a potent homicidal poison. British Medical Journal, 278, 350-351.
Kuntz, I. D., Blaney, J. M., Oatley, S. J., Langridge, R. and Ferrin, T. E. (1982) A geometric approach to macromolecule-ligand interactions. J. Mol. Biol., 161, 269-288.
Lebeda, F. J. and Olson, M. A. (1999) Prediction of a conserved, neutralizing epitope in ribosome-inactivating proteins. International Journal of Biological Macromolecules, 24, 19-26.
Lightstone, F. C., Prieto, M. C., Singh, A. K., Piqueras, M. C., Whittal, R. M., Knapp, M. S., Balhorn, R. and Roe, D. C. (2000) Identification of novel small molecule ligands that bind to tetanus toxin. Chem Res Toxicol., 13, 356-362.
Lord, J. M., Roberts, L. M. and Robertus, J. D. (1994) Ricin: structure, mode of action, and some current applications. FASEB J, 8, 201-208.
Marsden, C. J., Fulop, V., Day, P. J and Lord, J. M. (2004) The effects of mutations surrounding and within the active site on the catalytic activity of ricin A chain. Eur. J. Biochem., 271, 153-162.
Olson, M. A., Carra, J. H., Roxas-Duncan, V., Wannemacher, R. W., Smith, L. A., and Millard, C. B. (2004) Finding a new vaccine in the ricin protein fold. Protein Engineering, Design & Selection, 17, 391-397.
Olsnes, S. and Kozlov, J. V. (2001) Ricin. Toxicon 39:1723-1728.
Ouzounis, C. A., Coulson, R. M., Enright, A. J., Kunin, V., Pereira-Leal, J. B. (2003) Classification schemes for protein structure and function. Nat Rev Genet., 4, 508-519.
Peruski, A. H., and Peruski, Jr, L. F. (2003) Immunological methods for detection and identification of infectious disease and biological warfare agents. Clinical and Diagnostic Laboratory Immunology, 10, 506-513.
Portefaix, J.-M., S. Thebault, F. Bourgain-Guglielmetti, M. D. Del Rio, C. Granier, J.-C. Mani, I. Navarro-Teulon, M. Nicolas, T. Soussi, and B. Pau. 2000. Critical residues of epitopes recognized by several anti-p53 monoclonal antibodies correspond to key residues of p53 involved in interactions with the mdm2 protein. Journal of Immunological methods 244: 17-28.
Sayle, R. A. and Milner-White, E. J. 1995. RasMol: Biomolecular graphics for all. Trends in Biochemical Sciences, 20, 374-376.
Shuker, S. B., Hajduk, P. J., Meadows, R. P. and Fesik, S. W. (1996) Discovering High-Affinity Ligands for Proteins: SAR by NMR. Science, 274, 1531-1534.
Slezak, T., Kuczmarski, T., Ott, L., Torres, C., Medeiros, D., Smith, J., Truitt, B., Mulakken, N., Lam, M., Vitalis, E., Zemla, A., Zhou, C. E. and Gardner, S. (2003) Comparative genomics tools applied to bioterrorism defense. Briefings in Bioinformatics, 4, 133-149.
Wang, G., De, J., Schoeniger, J. S., Roe, D. C. and Carbonell, R. G. (2004) A hexamer peptide ligand that binds selectively to staphylococcal enterotoxin B: isolation from a solid phase combinatorial library. Journal of Peptide Research, 64, 51-64.
Wesche, J., Rapak, A. and Olsnes, S. (1999) Dependence of ricin toxicity on translocation of the toxin A-chain from the endoplasmic reticulum to the cytosol. J Biol Chem, 274, 34443-34449.
Weston, S. A., Tucker, A. D., Thatcher, D. R., Derbyshire, D. J. and Pauptit, R. A. (1994) Xray structure of recombinant ricin A-chain at 1.8 Å resolution. J. Mol Biol., 244, 410-422.
Yan, X., Hollis, T., Svinth, M., Day, P., Monzingo, A. F., Milne, G. W., Robertus, J. D. (1997) Structure-based identification of a ricin inhibitor. J Mol Biol, 266, 1043.
Zemla, A. (2003) LGA: a method for finding 3D similarities in protein structures. Nucleic Acid Research, 31, 3370-3374.
Zemla, A., Ecale Zhou, C., Slezak, T., Kuczmarski, T., Rama, D., Torres, C, Sawicka, D. and Barsky, D. (2005) AS2TS system for protein structure modeling and analysis. Nucleic Acids Research, 1;33(Web Server issue):W111-5.

What is claimed is:

1. A computer implemented method of scoring a set of residues that form a predetermined three-dimensional structure in a polypeptide, comprising:
identifying a set of aligned three-dimensional structures, said set of aligned three-dimensional structures comprising positional information for a plurality of residues comprising a reference polypeptide, a plurality of residues comprising a target polypeptide, and a plurality of residues comprising a near-neighbor polypeptide;
generating from said set of aligned three-dimensional structures a one-to-one set of corresponding residues, wherein said set of corresponding residues comprises residues from said target polypeptide, and residues from said near-neighbor polypeptide whose positions differ by less than a pre-determined distance from positions of residues in said reference polypeptide that comprise said predetermined three-dimensional structure;
generating a plurality of conservation scores for corresponding reference and target residues comprising said one-to-one set, wherein said conservation scores are based on a first similarity metric;
generating a plurality of uniqueness scores for corresponding reference and near-neighbor residues comprising said one-to-one set, wherein said unique scores are based on a second similarity metric;
generating a plurality of composite scores for one or more of: said reference residues, said target residues, or said near-neighbor residues comprising said one-to-one set using said conservation score and said uniqueness score; and
storing said plurality of composite scores.

2. The method of claim 1, wherein said positional information comprises positional information for an alpha carbon atom, a beta carbon atom, or a side chain atom.

3. The method of claim 1, wherein said predetermined distance is less than 10 Angstroms.

4. The method of claim 3, wherein said predetermined distance is less than 5 Angstroms.

5. The method of claim 1, wherein said one-to-one set comprises 3 or more reference residues and wherein 3 or more composite scores are generated and stored.

6. The method of claim 5, further comprising generating a distribution of said composite scores and selecting a subset of residues based on a percentile cutoff from said distribution.

7. The method of claim 1, further comprising displaying said composite scores with a representation of a three-dimensional structure of said reference, target, or near-neighbor polypeptide residues.

8. The method of claim 7, wherein said representation is a three-dimensional representation of said target.

9. The method of claim 7, wherein said representation is a representation of an aligned structure.

10. The method of claim 1, further comprising displaying said composite scores with a linear representation of said reference residues, said target residues, or said near-neighbor residues.

11. The method of claim 1, further comprising combining said plurality of composite scores with a plurality of scores indicative of the probability that a residue is a surface residue.

12. The method of claim 1 further comprising combining said plurality of composite scores with a plurality of scores indicative of the frequency a reference polypeptide residue within local sequence context occurs in a data set of polypeptide sequences.

13. The method of claim 7, further comprising identifying a structural feature comprising 3 residues.

14. The method of claim 1, wherein said set of aligned three-dimensional structures comprises a structure obtained using x-ray crystallography, electron crystallography, nuclear magnetic resonance, computational protein structure modeling, or combinations thereof.

15. The method of claim 1, wherein said set of aligned three-dimensional structures comprises positional information for a plurality of residues comprising three target polypeptides.

16. The method of claim 1, wherein said set of aligned three-dimensional structures comprises positional information for a plurality of residues comprising three nearest-neighbor polypeptides.

17. The method of claim 1, wherein said first or second similarity metric incorporates information about residue identity, residue non-identity and residue class, information defined by a substitution matrix or a combination thereof.

18. The method of claim 1, further comprising identifying said target polypeptide using a sequence similarity comparison, a structural similarity comparison, or a taxonomic comparison to said reference polypeptide.

19. The method of claim 1, further comprising identifying said nearest-neighbor polypeptide using a sequence similarity comparison, a structural similarity comparison, or a taxonomic comparison to said reference polypeptide.

20. A computer readable storage medium encoded with program code for scoring a set of residues that form a predetermined three-dimensional structure in a polypeptide, the program code comprising:
program code for identifying a set of aligned three-dimensional structures, said set of aligned three-dimensional structures comprising positional information for a plurality of residues comprising a reference polypeptide, a plurality of residues comprising a target polypeptide, and a plurality of residues comprising near-neighbor polypeptide;
program code for generating from said set of aligned three-dimensional structures a one-to-one set of corresponding residues, wherein said set of corresponding residues comprises residues from said target polypeptide, and residues from said near-neighbor polypeptide whose positions differ by less than a pre-determined distance from positions of residues in said reference polypeptide that comprise said predetermined three-dimensional structure;
program code for generating a plurality of conservation scores for corresponding reference and target residues comprising said one-to-one set, wherein said conservation scores are based on a first similarity metric;
program code for generating a plurality of uniqueness scores for corresponding reference and near-neighbor residues comprising said one-to-one set, wherein said unique scores are based on a second similarity metric;
program code for generating a plurality of composite scores for one or more of:
said reference residues, said target residues, or said near-neighbor residues comprising said one-to-one set using said conservation score and said uniqueness score; and
program code for storing said plurality of composite scores.
